(19) United States
(12) Patent Application Publication
(10) Pub. No.: US 2017/0102217 A1
(43) Pub. Date: Apr. 13, 2017

(54) EARLY WARNING PROJECTILE PENETRATION SYSTEM

(71) Applicant: Amos Golan, Ramat Gan (IL)

(72) Inventor: Amos Golan, Ramat Gan (IL)

(21) Appl. No.: 15/289,365

(22) Filed: Oct. 10, 2016

(30) Foreign Application Priority Data
Oct. 13, 2015 (IL) 242059

(51) Int. Cl. F41J 11/02; F41H 5/04; G09B 9/00; F41H 5/24

(52) U.S. Cl. CPC F41J 11/02; F41H 5/24; F41H 5/0457; G09B 9/003; F41J 5/04

(57) ABSTRACT

An early warning projectile penetration system includes a shoot house including a wall constructed of at least one inner layer of a ballistic penetration-resistant material, an outer layer of construction material, and a penetration detection system disposed intermediate the at least one inner layer and the outer layer. The penetration detection system is operative to provide an indication if a projectile has passed through the ballistic penetration-resistant material.

### FIELD OF THE INVENTION

The present invention relates generally to projectile containment assembly safety devices and, more specifically, to a system that provides early indication or warning of an imminent failure of the projectile containment assembly.

### BACKGROUND OF THE INVENTION

Certain personnel such as police and members of the armed forces have jobs that require them to carry and use fire arms. For their own and the public's safety, armed personnel must be properly trained. Traditionally, much of this training occurs at firing ranges. However, for these personnel to safely use their firearms, a large portion of training must occur in more realistic settings. To accomplish this, additional training may occur on specifically designed assault courses including structures commonly known as shoot houses. These structures provide for many actual combat situations where trainees must quickly and accurately identify and respond to realistic threats to their safety.

To better simulate actual combat situations, training is generally conducted in groups using live ammunition. Since personnel may need to quickly fire their weapon as they enter a room, it is necessary that the shoot house walls be able to withstand the impact of multiple rounds of ammunition. Shoot house walls must also be constructed to prevent bullets from ricocheting off the wall and injuring trainees. Traditional shoot houses were originally constructed out of concrete, tires, or gravel filled walls. As technology improved, shoot houses have become more sophisticated and better able to stop bullets and ricocheting. However, even with current technology, shoot house walls may fail without warning.

Firing ranges pose many of the same threats to nearby personnel as a shoot house. The ranges must be configured in a manner that will stop bullets and prevent ricocheting bullets from injuring anyone nearby. Projectile containment assemblies are commonly used in both shoot house walls and firing ranges to stop projectiles and prevent ricocheting by slowing down and capturing the projectile.

Projectile containment assemblies are of widely varying configurations, from a single layer of solid concrete or thick steel, to a plurality of layers of various materials. By way of example, a containment assembly used in a known shoot house wall consists of a fixed containment assembly having three layers: a thick concrete anterior and posterior layer with and interior containment assembly layer consisting of a material to absorb and capture any bullets or fragments that may ricochet off the wall.

Projectile containment assemblies pose a significant threat to safety in that they may fail without warning if the various containment assembly layers become weakened or worn with prolonged use. Failure of the projectile containment assembly may then allow projectiles or bullets to impact the wall being protected damaging the wall and, ultimately, causing failure of the wall.

Merely inspecting the wall from the outside before implementing the training exercise does not solve the problem; the outer wall may have no signs of fatigue or cracks and yet the wall is already internally damaged such that a projectile can penetrate through the wall. A system is needed that will provide early indication or warning of an imminent failure of the projectile containment assembly or wall assembly.

U.S. Pat. No. 8,875,613 describes a removable inspection panel to monitor the soundness of projectile containment assemblies and indicate, for example, when a shoot house wall is no longer safe.

### SUMMARY OF THE INVENTION

The present invention seeks to provide an improved system that provides early indication or warning of an imminent failure of a projectile containment assembly, as described more in detail hereinbelow. The invention is applicable particularly for shoot houses, but may also be used for firing ranges that have projectile containment assemblies (the term shoot house being inclusive of such firing range assemblies).

There is thus provided in accordance with a non-limiting embodiment of the present invention an early warning projectile penetration system including a shoot house including a wall (preferably, but not necessarily, all walls) constructed of at least one inner layer of a ballistic penetration-resistant material, an outer layer of construction material, and a penetration detection system disposed intermediate the at least one inner layer and the outer layer, wherein the penetration detection system is operative to provide an indication if a projectile has passed through the ballistic penetration-resistant material.

In accordance with a non-limiting embodiment of the present invention the at least one inner layer includes a metal layer.

In accordance with a non-limiting embodiment of the present invention the at least one inner layer further includes a ballistic elastomeric or fiber material inwards of the metal layer.

In accordance with a non-limiting embodiment of the present invention the penetration detection system is operative to provide an indication when the projectile passed through the ballistic penetration-resistant material.

In accordance with a non-limiting embodiment of the present invention the penetration detection system is operative to provide spatial information where the projectile passed through the ballistic penetration-resistant material.

In accordance with a non-limiting embodiment of the present invention a transmitter is in communication with the penetration detection system for transmitting a warning of the projectile having passed through the ballistic penetration-resistant material.

There is provided in accordance with a non-limiting embodiment of the present invention a method for early warning projectile penetration including providing a shoot house including a wall constructed of at least one inner layer of a ballistic penetration-resistant material, an outer layer of construction material, and a penetration detection system disposed intermediate the at least one inner layer and the outer layer, and using the penetration detection system to provide an indication if a projectile has passed through the ballistic penetration-resistant material. The shoot house may be used for an exercise, and the exercise is stopped if the penetration detection system indicates a projectile has passed through the ballistic penetration-resistant material. The wall in the shoot house can then be repaired for further safe exercises.

### BRIEF DESCRIPTION OF THE DRAWINGS

The present invention will be understood and appreciated more fully from the following detailed description taken in conjunction with the drawings in which:

FIG. 1 is a simplified illustration of an early warning projectile penetration system installed in a shoot house, constructed and operative in accordance with a non-limiting embodiment of the present invention; and

FIG. 2 is a simplified illustration of the construction of the early warning projectile penetration system.

### DETAILED DESCRIPTION OF EMBODIMENTS

Reference is now made to FIG. 2, which illustrates an early warning projectile penetration system 10, constructed and operative in accordance with a non-limiting embodiment of the present invention.

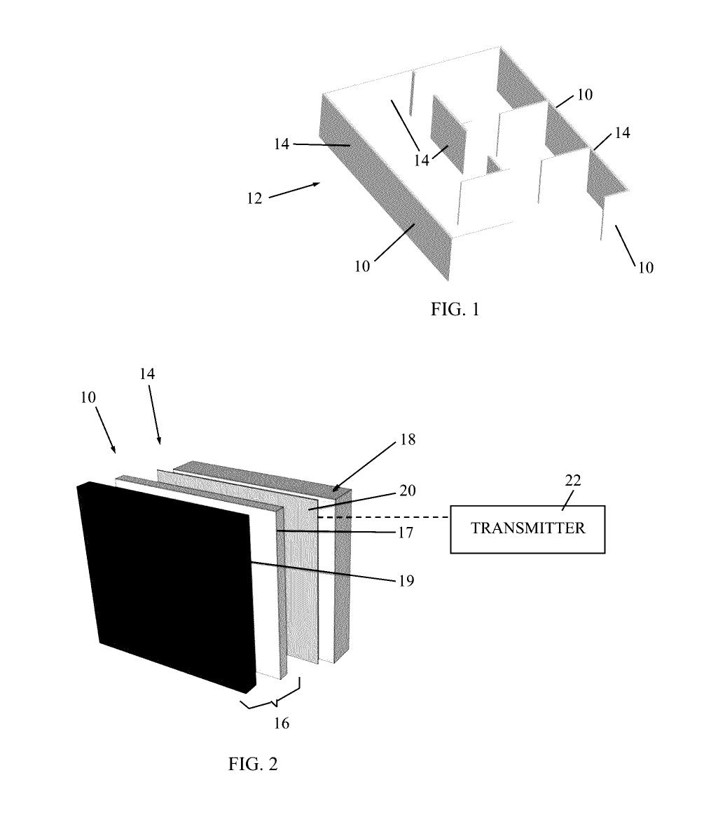

The early warning projectile penetration system 10 is shown in FIG. 1 installed in a shoot house 12, which includes a wall 14. The system 10 is preferably, but not necessarily, installed in all outer walls of the shoot house and may be installed in the inner walls as well.

FIG. 2 illustrates the construction of the early warning projectile penetration system. The wall 14 is constructed of at least one inner layer of a ballistic penetration-resistant material 16, an outer layer 18 of a construction material (such as, but not limited to, concrete), and a penetration detection system 20 disposed intermediate the at least one inner layer 16 and the outer layer 18. The penetration detection system 20 provides an indication if a projectile has passed through the ballistic penetration-resistant material 16.

As shown in the illustrated embodiment, the at least one inner layer includes a metal layer 17 (such as, but not limited to, steel) and a ballistic elastomeric or fiber material 19 inwards of the metal layer 17. Without limitation, material 19 may include thin, alternating layers of certain aramid and ultra-high-molecular-weight polyethylene (UHMWPE) fibers, or other ballistic fabric, and/or a synthetic viscoelastic polymer, such as polyisobutene or butyl rubber.

The penetration detection system 20 may include a short circuit type of detection system, which includes copper wires embedded in a substrate such as a fiber substrate. An example of such a system is described in U.S. Pat. No. 3,004,763, which includes two layers of electrically conductive material, a dielectric separating said layers, a first resistor having one end electrically connected to one layer and the other end electrically connected to the other layer, and a second resistor having one end connected to one layer and the other end electrically connected to ground. U.S. Pat. No. 3,580,579 describes another example, which includes target elements mounted one behind the other, each element including at least two electrically insulated parallel sheets of electrically conductive material, each conductive sheet being connected to a terminal included in an electric circuit. The two conductive sheets of each target element are temporarily electrically connected when a projectile penetrates the two sheets and the respective circuit is closed. At least two of the target elements are situated in planes inclined with respect one another, whereby the relatively inclined target elements, when traversed by a projectile, produce pulses in timed sequence, the time interval between the pulses being dependent on the position of the hit point of the projectile on the target.

WO1982004476 describes another example of a suitable detecting device, which may be used as the penetration detection system 20. In this example, a multi-layer sheet structure is made of interconnected rubber-based layers; there are one or more separating insulating layers between the electrically conductive layers. When a projectile penetrates, electrical contact is established between the conductive layers insulated from each other and this contact is detected by electric detecting units.

Other systems use pressure or motion sensors for detecting penetration of the projectile, and these systems may also be utilized as the penetration detection system 20.

The penetration detection system can provide an indication when the projectile passed through the ballistic penetration-resistant material. In addition, it can provide spatial information where the projectile passed through the ballistic penetration-resistant material.

A transmitter 22 (wired or wireless) may be in communication with the penetration detection system 20 for transmitting a warning of the projectile having passed through the ballistic penetration-resistant material. For example, the early warning projectile penetration system 10 is capable of transmitting status, data and events over wireless, Bluetooth and cellular networks.

With the present invention, the shoot house may be used for an exercise, and the exercise may be stopped if the penetration detection system indicates a projectile has passed through the ballistic penetration-resistant material. The early warning projectile penetration system 10 can detect penetration of projectiles, secondary projectiles and fragmentation. The wall in the shoot house can then be repaired for further safe exercises.

The early warning projectile penetration system 10 is capable of performing various functions (for example, by means of a processor incorporated in the penetration detection system 20 or a remote processor in wired or wireless communication with penetration detection system 20). For example, system 10 performs self-diagnostics upon operation, which checks the integrity of the system. Examples of self-diagnostics include, without limitation, testing if the projectile penetration detectors are operating correctly, testing if the transmitters that send warnings of penetration are operating correctly, and testing the functionality of other components of the system.

In another example, the early warning projectile penetration system 10 can store operational history of status and past events. This helps personnel evaluate and analyze the integrity of the shoot house and enhance safety measures.

What is claimed is:

1. An early warning projectile penetration system comprising:
a shoot house comprising a wall constructed of at least one inner layer of a ballistic penetration-resistant material, an outer layer of construction material, and a penetration detection system disposed intermediate said at least one inner layer and said outer layer, wherein said penetration detection system is operative to provide an indication if a projectile has passed through said ballistic penetration-resistant material.

2. The system according to claim 1, wherein said at least one inner layer comprises a metal layer.

3. The system according to claim 2, wherein said at least one inner layer further comprises a ballistic elastomeric or fiber material inwards of said metal layer.

4. The system according to claim 1, wherein said penetration detection system is operative to provide an indication when said projectile passed through said ballistic penetration-resistant material.

5. The system according to claim 1, wherein said penetration detection system is operative to provide spatial information where said projectile passed through said ballistic penetration-resistant material.

6. The system according to claim 1, further comprising a transmitter in communication with said penetration detection system for transmitting a warning of said projectile having passed through said ballistic penetration-resistant material.

7. A method for early warning projectile penetration comprising:
providing a shoot house comprising a wall constructed of at least one inner layer of a ballistic penetration-resistant material, an outer layer of construction material, and a penetration detection system disposed intermediate said at least one inner layer and said outer layer, and using said penetration detection system to provide an indication if a projectile has passed through said ballistic penetration-resistant material.

8. The method according to claim 7, using the shoot house for an exercise, and stopping the exercise if said penetration detection system indicates a projectile has passed through said ballistic penetration-resistant material.

9. The method according to claim 7, further comprising performing self-diagnostics of said penetration detection system.

10. The method according to claim 7, further comprising storing operational history of status and past events.
